(19) United States
(12) Patent Application Publication
(10) Pub. No.: US 2022/0136592 A1
(43) Pub. Date: May 5, 2022

(54) LINEAR ACTUATOR AND CONSTRUCTION KIT FOR PRODUCING SAID LINEAR ACTUATOR

(71) Applicant: Schaeffler Technologies AG & Co. KG, Herzogenaurach (DE)

(72) Inventor: Joachim BOCKENHEIMER, Etzling (FR)

(73) Assignee: Schaeffler Technologies AG & Co. KG, Herzogenaurach (DE)

(21) Appl. No.: 17/432,306

(22) PCT Filed: Dec. 6, 2019
(86) PCT No.: PCT/DE2019/101053

§ 371 Date: Aug. 19, 2021

(30) Foreign Application Priority Data
Feb. 20, 2019 (DE) 10 2019 104 252.6

(51) Int. Cl. F16H 25/24

(52) U.S. Cl. CPC F16H 25/24; F16H 2025/2053

(57) ABSTRACT

A linear actuator, which is assembled from a plurality of structurally identical individual actuators, each of which has a housing and an output shaft which is arranged to be longitudinally displaceable in the housing and which penetrates the housing, wherein the housing is designed on its outer surface as a polygonal profile with polygonal sides of equal length, which define outer polygonal surfaces arranged around the output shaft, wherein at least one of the polygonal surfaces of the housing is intended to rest against one of the polygonal surfaces of one of the other housings. The output shafts are coupled to one another by a common coupling element for common adjusting movements and for a parallel connection of the actuating forces acting in the individual actuators.

### CROSS-REFERENCE TO RELATED APPLICATIONS

This application is the U.S. National Phase of PCT Appln. No. PCT/DE2019/101053, filed Dec. 6, 2019, which claims priority to DE 102019104252.6, filed Feb. 20, 2019, the entire disclosures of which are incorporated by reference herein.

### TECHNICAL FIELD

The present disclosure relates to a linear actuator and a construction kit for producing said linear actuator.

### BACKGROUND

A linear actuator is known from DE102013222649 A1. The linear actuator has a housing and a rotor of an electric motor arranged in the housing, as well as a screw drive driven by the electric motor. The threaded spindle forms an output shaft which is arranged to be longitudinally displaceable relative to the housing and which penetrates the housing.

This linear actuator is designed in different sizes depending on the application and power requirement, so that a plurality of different linear actuators must be provided.

### SUMMARY

The object of the present disclosure was to reduce the number of different linear actuators.

According to the disclosure, this object was achieved by the linear actuator having one or more of the features described herein. The linear actuator is assembled from a plurality of structurally identical individual actuators. Depending on the power requirement, a plurality of structurally identical individual actuators can be combined to form a linear actuator and their output shafts can be connected to one another, i.e. connected in parallel. The total power increases with the number of individual actuators connected together. Structurally identical in this context means in particular that the external shape of the individual actuators is the same.

These individual actuators each have a housing and an output shaft which is arranged to be longitudinally displaceable relative to the housing and which penetrates the housing.

The individual actuator preferably has a screw drive which is connected to the output shaft, which is displaced longitudinally relative to the housing when the screw drive is actuated.

An electric motor, which drives the screw drive, for example, can be arranged in the housing. The housing can also be part of the stator of the electric motor or accommodate its motor housing. The rotor of the electric motor can drive the screw drive, which is advantageously formed by a planetary roller screw drive which is known per se. A trapezoidal screw drive or a ball screw drive are other alternatives. The threaded spindle or a nut of the screw drive that interacts with the threaded spindle can also be or form part of an output shaft which is arranged so as to be longitudinally displaceable relative to the housing and penetrating the housing. The output shaft can be guided in the housing so as to be longitudinally displaceable and secured against rotation. In the case of a rotationally driven threaded spindle, the nut is secured against rotation relative to the housing and is arranged to be longitudinally displaceable and also forms part of or is the output shaft that penetrates the housing. In the case of a rotationally driven nut, the threaded spindle is secured against rotation relative to the housing and is arranged to be longitudinally displaceable and forms part of or is the output shaft that penetrates the housing. In the case of a planetary roller screw drive, the planetary rollers can be mounted in a planetary roller carrier which is arranged between the nut and the threaded spindle. In this case, the planetary roller carrier can be rotationally driven. The threaded spindle is secured against rotation relative to the housing and is arranged to be longitudinally displaceable and also forms part of or is the output shaft that penetrates the housing.

The housing is designed on its outer surface as a polygonal profile with polygonal sides of the same length, which define the outer polygonal surfaces that surround the output shaft. These polygonal surfaces can all be arranged parallel to the axis of the output shaft. At least one of the polygonal surfaces of the housing is intended to rest against one of the polygonal surfaces of one of the other housings. This means that, for example, two individual actuators can be brought into contact with one another on their facing polygonal surfaces and fixed to one another. Preferably, all of the polygonal surfaces distributed over the circumference are of the same type, so that any two polygonal surfaces can be brought into contact by two individual actuators.

In this case, the linear actuator can be provided with a coupling element that couples the output shafts of a plurality of individual actuators to one another for common adjusting movements. The coupling element focuses an actuating force acting in the respective output shafts of the individual actuators, thus serves to connect the actuating forces acting in the individual actuators in parallel. In a simple embodiment, this coupling element can be designed as a combination plate, to which the output shafts of all individual actuators combined with one another are attached, wherein the combination plate has at least two receptacles for the output shafts of the individual actuators. This means that a total output of the linear actuator corresponding to the number of individual actuators used can be provided via the coupling element. It is conceivable, for example, to use only one individual actuator when there is only a very low power requirement, and to connect a corresponding number of these individual actuators in parallel in a common assembly when the power requirement increases. The coupling element can have a central output shaft which, depending on the application, can be connected to other machine elements. The coupling element moves together with the output shafts of the individual actuators.

The packing density of the connected assemblies of individual actuators can be designed differently, depending on the design of the polygonal profile.

In numerous applications, compact linear actuators with high performance requirements are desired. It is particularly advantageous here to design the polygonal profile as a hexagonal profile. If a plurality of these individual actuators are connected together, a honeycomb arrangement of the individual actuators is provided with a high packing density. Two adjacent hexagonal surfaces of the same housing can be brought into contact on two polygonal surfaces which are formed on one each of the additional housings. In this arrangement, an assembly of several individual actuators is accordingly provided to form a linear actuator. Of course, it can be sufficient to connect two individual actuators together. However, it is also possible to combine three, four or more individual actuators without any problems.

The polygonal profile can alternatively be provided by a triangular profile, wherein two triangular surfaces arranged adjacently to one another are provided for contacting two triangular surfaces which are formed on one each of the additional housings. In this arrangement, an assembly of at least two individual actuators can consequently be provided to form a linear actuator.

The polygonal profile can also be designed as an octagonal profile, wherein two octagonal surfaces adjoining a central octagonal surface on the circumference are in contact with two octagonal surfaces which are formed on one each of the additional housings. If, for example, four such individual actuators are combined in a closed annular shape, a central passage is created, formed by the four individual actuators, which can serve, for example, to accommodate a holder to which this linear actuator is attached.

The housing of the individual actuator can be designed on its inner surface as a polygonal profile with polygonal sides of the same length, which define the inner polygonal surfaces that surround the output shaft.

The inner and/or outer polygonal surfaces of the housing can be used as functional surfaces. The outer polygonal surfaces are preferably provided with mounting protrusions and mounting receptacles for connecting individual actuators to one another, which protrusions and receptacles are arranged distributed over the circumference. In this case, a mounting protrusion of one housing is assigned to a mounting receptacle of one of the other housings. A simple development can provide a plurality of blind holes on the outer circumference of the housing. Dowels can be used as connecting elements in one or more of these blind holes. If another housing is then to be connected, this dowel engages in a blind hole in the additional housing.

The outer polygonal surfaces can also be used to attach nameplates or to accommodate external position contacts. The inner polygonal surfaces can be used to absorb torques that act between the rotor and the stator of the electric motor. The inner polygonal surfaces can be used to hold material measures or sensors if an axial travel path between the housing and the output shaft is to be measured. The inner polygonal surfaces can be used to guide a threaded nut. This may be useful if the threaded spindle is driven by the electric motor and the threaded nut is to be guided in a longitudinally displaceable manner and secured against rotation relative to the housing.

In the case of a planetary screw drive, it is expedient if this is of the type of a planetary screw drive with a true pitch. In many cases, such planetary screw drives have a threaded spindle and planets with adjacent, self-contained grooves that mesh with the thread of the threaded spindle, and a nut with self-contained grooves formed on the inner circumference that mesh with the grooves of the planets. In order to ensure that a slippage between the planets and the nut or the threaded spindle has no influence on an adjustment path of the output shaft, it is particularly advantageous if the planetary rollers are accommodated in a planetary roller carrier that is rotationally driven, i.e. rotates about the threaded spindle. Alternatively, it is possible to rotationally drive the threaded spindle. In both cases, a relative rotation between the planets and the threaded spindle of 360 degrees corresponds to the pitch of the thread of the threaded spindle. Such planetary screw drives are particularly advantageous for linear actuators according to the disclosure.

A further object of the disclosure is to specify a construction kit for producing said linear actuator. This construction kit comprises a series of structurally identical individual actuators as well as a plurality of different coupling elements—which can be formed by combination plates—for each series of individual actuators. Different coupling elements have a different number of receptacles for the output shafts of the individual actuators. Within a series of structurally identical individual actuators, a center-to-center distance between two output shafts of two combined individual actuators is always the same. The coupling elements assigned to this series have an equally sized center-to-center distance between their receptacles for the output shafts. If only two individual actuators are to be assembled, it may be sufficient to provide a coupling element with only two receptacles. If more than two individual actuators are to be assembled, the coupling element is enlarged accordingly and has a corresponding number of receptacles.

### BRIEF DESCRIPTION OF THE DRAWINGS

The disclosure is explained in more detail below with the aid of ten figures. In the figures:

FIG. 1 shows a schematic cross-sectional view of an individual actuator of a linear actuator according to the disclosure,

FIG. 2 shows the individual actuator from FIG. 1,

FIG. 3 shows a perspective view of the individual actuator from FIG. 2,

FIG. 4 shows a linear actuator according to the disclosure,

FIG. 5 shows a further view of the linear actuator from FIG. 4,

FIG. 6 shows a further linear actuator according to the disclosure,

FIG. 7 shows a further view of the linear actuator from FIG. 6,

FIG. 8 shows a diagram of a further linear actuator according to the disclosure,

FIG. 9 shows a diagram of a further linear actuator according to the disclosure,

FIG. 10 shows a diagram of a further linear actuator according to the disclosure.

### DETAILED DESCRIPTION

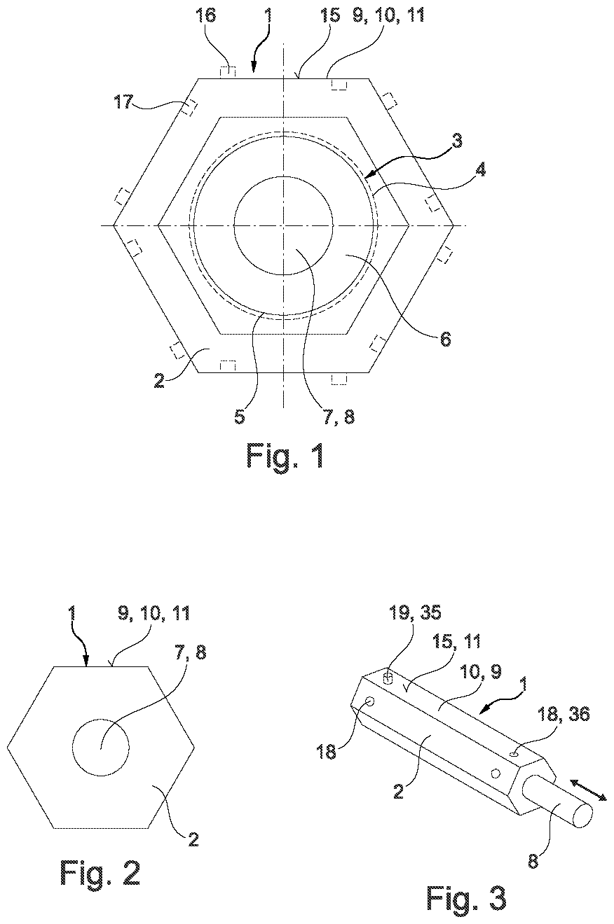

FIGS. 1 to 3 show an individual actuator 1, which has a housing 2 and an electric motor 3 arranged in the housing 2, the rotor 4 of which is shown here only in dashed lines and drives a screw drive 5, the rotationally driven nut 6 of which cooperates with a threaded spindle 7. The threaded spindle 7 is part of an output shaft 8 which penetrates the housing 2 and is guided in a longitudinally displaceable manner and secured against rotation relative to the housing 2.

The housing 2 is designed on its outer surface as a polygonal profile 9 with polygonal sides 10 of the same length, which define outer polygonal surfaces 11 arranged around the output shaft 8.

In this exemplary embodiment, the polygonal profile 9 is formed by a hexagonal profile with hexagonal faces which form the polygonal surfaces 11.

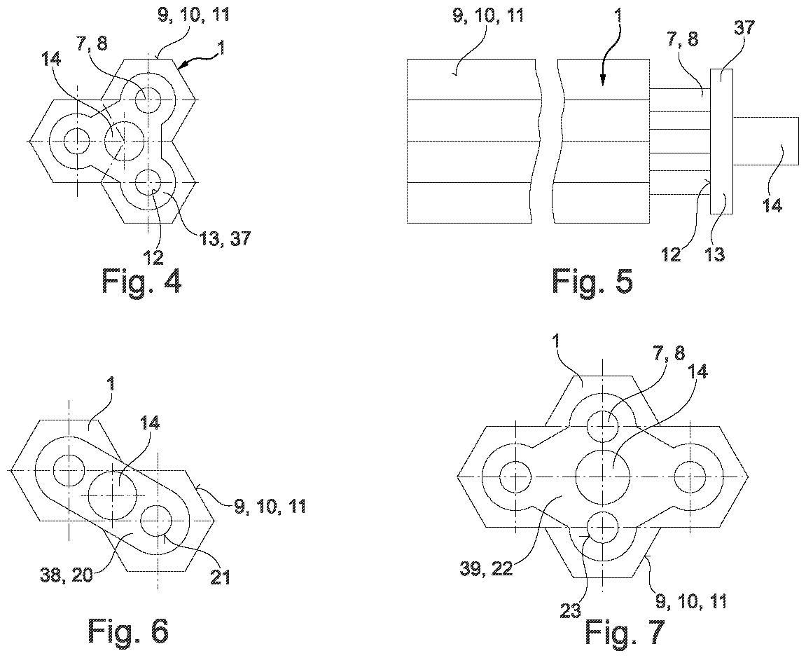

It can be seen from FIG. 1 that the polygonal surfaces 11 are designed as functional surfaces 15 and have mounting protrusions 16 and mounting receptacles 17 distributed around the circumference for connecting individual actuators to one another. The arrangement is selected here such that a mounting protrusion 16 of one housing 2 is assigned to a mounting receptacle 17 of a housing 2 of another individual actuator 1. This is the case when two of these individual actuators 1 are brought into contact with one another via their facing polygonal surfaces 11, as is shown, for example, in FIGS. 4 and 5.

The mounting protrusions 16 and mounting receptacles 17 in FIG. 1 lie next to one another over the circumference and at a common height along the longitudinal axis of the individual actuator.

A variant of this is indicated in FIG. 3: The functional surfaces 15 are provided with blind holes 18 at their axial end portions. If two such individual actuators 1 are to be brought into contact with one another via their facing polygonal surfaces 11, pins 19 can be inserted into the two blind holes 18 on one individual actuator 1. The protruding pins 19 form mounting protrusions 35 which engage in the blind holes 18 of the other individual actuator 1 that form the mounting receptacles 36 in order to connect the two individual actuators 1 to one another.

With the two variants described, perfect positioning and connection of the individual actuators 1 to one another can be ensured.

FIGS. 4 and 5 show a first linear actuator which is assembled from three such individual actuators 1. It can be clearly seen that the three individual actuators 1 rest against one another via their facing polygonal surfaces 11. These polygonal surfaces 11 are all arranged parallel to the output shafts 8. The dashed lines show the abutting polygonal surfaces 11 of the three individual actuators 1.

The three output shafts 8 are attached to receptacles 12 of a common combination plate 13, for example by a screw or clamp connection. The combination plate 13 carries a central output shaft 14 which is arranged parallel to the output shafts 8 of the individual actuators 1.

When the linear actuator is actuated, the three individual actuators 1 are energized and the output shafts 8 of the individual actuators move together in a desired stroke. This stroke is transmitted via the combination plate 13 and the central output shaft 14 to a machine element (not shown). The parallel connection of the three individual actuators 1 means a tripling of the actuating force available at the central output shaft 14.

FIGS. 6 and 7 show two further linear actuators which are assembled from a plurality of such individual actuators 1. According to FIG. 6, two individual actuators 1 are connected to one another. According to FIG. 6, four individual actuators 1 are connected to one another. Combination plates of different sizes are used depending on the number of assembled individual actuators 1. The exemplary embodiment according to FIG. 6 shows a combination plate 20 with only two receptacles 21 for output shafts 8 of the individual actuators 1. The exemplary embodiment according to FIG. 7 shows a combination plate 22 with four receptacles 23 for output shafts 8 of the individual actuators 1. These combination plates 20, 22 each carry one of the central output shafts 14.

FIG. 8 shows a diagram of an assembly of six individual actuators 24 which form a linear actuator, the housings 25 of which have a polygonal profile in the form of an equilateral triangle. Otherwise, these individual actuators 24 can have the same structure as the individual actuators 1 described above. It can be clearly seen that all of the individual actuators 24 rest against one another via their facing polygonal surfaces 27.

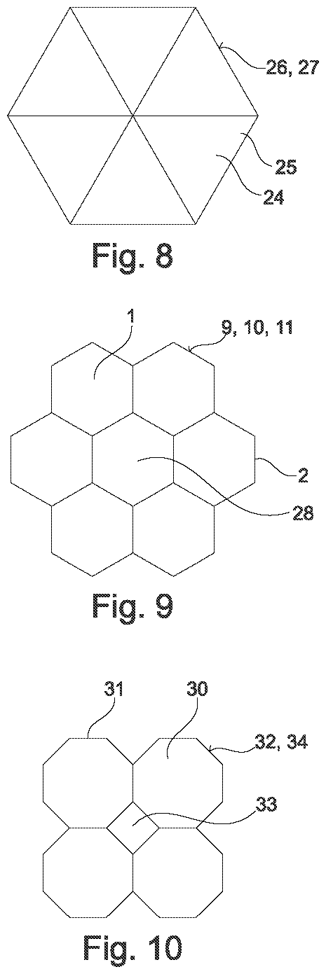

FIG. 9 shows a diagram of an assembly of six individual actuators 1 which form a linear actuator, as has already been described in the exemplary embodiment according to FIG. 1. It can be clearly seen that all of the individual actuators 1 are arranged annularly and rest against one other via their facing polygonal surfaces 11. In the center of the annular arrangement, a central opening 28 is formed, which can be used, for example, to hold the entire assembly of this linear actuator. For example, a hexagonal rod could be used on which each individual linear actuator is held.

FIG. 10 uses a diagram to show an assembly of four individual actuators 30 which form a linear actuator, the housings 31 of which have a polygonal profile 32 in the form of an equilateral octagon and form an octagonal profile. Otherwise, these individual actuators 30 can have the same structure as the individual actuators 1 described above. It can be clearly seen that all of the individual actuators 30 rest against one another via their facing polygonal surfaces 34. In the center of the annular arrangement, a central opening 33 is formed, which can be used, for example, to hold the entire assembly of this linear actuator. For example, a square rod could be used, on which each individual actuator 30 is held.

In each of the exemplary embodiments, adapted combination plates are provided, as described above. The design of said combination plates follows the arrangement of the individual actuators and the position of the output shafts. These combination plates can have, for example, two, three, four, five or six receptacles for mounting the output shafts of the individual actuators.

All of the linear actuators described here are built from a common construction kit. This construction kit includes, for example, the series of individual actuators 1, 24, 30 described here as well as a plurality of different combination plates for each series of individual actuators. The combination plates differ in the number of receptacles and the center-to-center distance of the receptacles. Since the honeycomb shape enables a particularly favorable packing density, a simple construction kit can have merely the series of individual actuators with a hexagonal profile and a plurality of different combination plates, depending on the number of individual actuators combined with one another.

The combination plates 13, 20, 22 proposed in the exemplary embodiments described above can be referred to in a general form as coupling elements 37, 38, 39 which couple the output shafts of several individual actuators to one another for common adjusting movements.

### LIST OF REFERENCE SIGNS

1 Individual actuator
2 Housing
3 Electric motor
4 Rotor
5 Screw drive
6 Nut
7 Threaded spindle
8 Output shaft
9 Polygonal profile
10 Polygonal sides
11 Polygonal surface
12 Receptacle
13 Combination plate
14 Central output shaft
15 Functional surface
16 Mounting protrusion
17 Mounting receptacle
18 Blind hole
19 Pin
20 Combination plate
21 Receptacle
22 Combination plate
23 Receptacle
24 Individual actuator
25 Housing
26 Polygonal profile
27 Polygonal surface
28 Central opening
29 Central opening
30 Individual actuator
31 Housing
32 Polygonal profile
33 Central opening
34 Polygonal surface
35 Mounting protrusions
36 Mounting receptacles
37 Coupling element
38 Coupling element
39 Coupling element

1. A linear actuator, comprising:
a plurality of structurally identical individual actuators, each of which has a housing and an output shaft arranged to be longitudinally displaceable relative to the housing and which penetrates the housing;
each of the housings have an outer surface with a polygonal profile with polygonal sides of equal length, which define outer polygonal surfaces arranged around the output shaft; and
the plurality of structurally identical actuators are assembled with at least one of the polygonal surfaces of one of the housings resting against one of the polygonal surfaces of one of the other housings.

2. The linear actuator according to claim 1, wherein the individual actuators each have a rotor of an electric motor arranged in the housing and a screw drive, which is driven by the electric motor and the screw drive includes the output shaft which is arranged to be longitudinally displaceable relative to the housing and penetrates the housing.

3. The linear actuator according to claim 1, wherein the polygonal profile is formed by a triangular profile, and two triangular surfaces arranged adjacent to one another on one of the housings rest against two triangular surfaces that are formed on one each of two of the additional housings.

4. The linear actuator according to claim 1, wherein the polygonal profile is formed by a hexagonal profile, and two hexagonal surfaces arranged adjacent to one another on one of the housings to rest against two hexagonal surfaces that are formed on one each of two of the additional housings.

5. The linear actuator according to claim 1, wherein the polygonal profile is formed by an octagonal profile, and two octagonal surfaces adjoining a central octagonal surface circumferentially on one of the housings rest against two octagonal surfaces that are formed on one each of two of the additional housings.

6. The linear actuator according to claim 1, wherein the housing of each of the individual actuators has an inner surface with a polygonal profile with polygonal sides of equal length that define the outer polygonal surfaces arranged around the output shaft.

7. The linear actuator according to claim 1, wherein the outer polygonal surfaces are functional surfaces.

8. The linear actuator according to claim 7, wherein the housing of each of the individual actuators include circumferentially distributed mounting protrusions and mounting receptacles for connecting individual ones of the actuators to one another arranged on the functional surfaces, and one of the mounting protrusions of one of the housings is connected to a mounting receptacle of one of the other housings.

9. The linear actuator according to claim 1, further comprising a coupling element configured to combine the output shafts of all individual actuators with one another, the coupling element includes at least two receptacles for the output shafts of the individual actuators and a central output shaft.

10. A construction kit for producing a linear actuator according to claim 9, comprising at least one series of the structurally identical individual actuators and a plurality of different ones of the coupling element for each of the series of individual actuators, and the different ones of the coupling elements have a different number of the receptacles for the output shafts of the individual actuators.

11. A linear actuator, comprising:
a plurality of structurally identical individual actuators, each of which has a housing and an output shaft arranged to be longitudinally displaceable relative to the housing and which penetrates the housing;
each of the housings have an outer surface with a polygonal profile with polygonal sides of equal length, which define outer polygonal surfaces arranged around the output shaft;
the plurality of structurally identical actuators are assembled with at least one of the polygonal surfaces of one of the housings resting against one of the polygonal surfaces of one of the other housings; and
a coupling configured to connect the output shafts of individual ones of the actuators to a central output shaft.

12. The linear actuator according to claim 11, wherein the individual actuators each have an electric motor-driven screw drive, and the screw drive includes the output shaft which is arranged to be longitudinally displaceable relative to the housing and penetrates the housing.

13. The linear actuator according to claim 11, wherein the polygonal profile is formed by a triangular profile, and two triangular surfaces arranged adjacent to one another on one of the housings rest against two triangular surfaces that are formed on one each of two of the additional housings.

14. The linear actuator according to claim 11, wherein the polygonal profile is formed by a hexagonal profile, and two hexagonal surfaces arranged adjacent to one another on one of the housings rest against two hexagonal surfaces that are formed on one each of two of the additional housings.

15. The linear actuator according to claim 11, wherein the polygonal profile is formed by an octagonal profile, and two octagonal surfaces adjoining a central octagonal surface circumferentially on one of the housings rest against two octagonal surfaces that are formed on one each of two of the additional housings.

16. The linear actuator according to claim 11, wherein the housing of each of the individual actuators has an inner surface with a polygonal profile with polygonal sides of equal length that define the outer polygonal surfaces arranged around the output shaft.

17. The linear actuator according to claim 11, wherein the outer polygonal surfaces are functional surfaces.

18. The linear actuator according to claim 17, wherein the housing of each of the individual actuators include circumferentially distributed mounting protrusions and mounting receptacles for connecting individual ones of the actuators to one another arranged on the functional surfaces, and one of the mounting protrusions of one of the housings is connected to a mounting receptacle of one of the other housings.

19. The linear actuator according to claim 11, wherein the coupling includes at least two receptacles for the output shafts of the individual actuators that are connected to the central output shaft.

20. A construction kit for producing a linear actuator according to claim 19, comprising at least one series of the structurally identical individual actuators and a plurality of different ones of the coupling for each of the series of individual actuators, and the different ones of the couplings have a different number of the receptacles for the output shafts of the individual actuators.
